(19) United States
(12) Patent Application Publication
(10) Pub. No.: US 2026/0332903 A1
(43) Pub. Date: Oct. 22, 2026

(54) ELECTRONIC DEVICE AND METHOD OF OPERATING THE SAME

(71) Applicant: SAMSUNG ELECTRONICS CO., LTD., Suwon-si (KR)

(72) Inventors: Kirim PARK, Suwon-si (KR); Hyeogman KWON, Suwon-si (KR); Seyoun LIM, Suwon-si (KR)

(73) Assignee: SAMSUNG ELECTRONICS CO., LTD., Suwon-si (KR)

(21) Appl. No.: 19/468,001

(22) Filed: Feb. 3, 2026

(30) Foreign Application Priority Data
Feb. 6, 2025 (KR) 10-2025-0015362

(51) Int. Cl. H04N 23/80; H04N 23/667

(52) U.S. Cl. CPC H04N 23/80; H04N 23/667

(57) ABSTRACT

An electronic device includes a processor configured to perform an image processing operation on a captured image generated in response to a photographing input, and a memory configured to provide a space required for the image processing operation of the processor. The processor, when the photographing input is received, allocates a memory space required for the image processing operation based on expected photographing pattern data generated by a machine learning model.

### CROSS-REFERENCE TO RELATED APPLICATION

This application is based on and claims priority under 35 U.S.C. § 119 to Korean Patent Application No. 10-2025-0015362, filed on Feb. 6, 2025, in the Korean Intellectual Property office, the disclosure of which is incorporated by reference herein in its entirety.

### BACKGROUND

The inventive concept relates to an electronic device performing an image processing operation.

Electronic devices may capture images by using a camera. The electronic devices may process the captured image by using an image signal processor. The image signal processor may perform an image processing operation by using a space allocated to a memory. In this case, for the image signal processor to quickly perform the image processing operation with less power, the memory used by the image signal processor is required to be allocated by as much as the required amount at a proper time point.

### SUMMARY

The inventive concept provides an electronic device allocating efficiently a memory space required for an image processing operation.

According to an aspect of the inventive concept, there is provided an electronic device including a processor configured to perform an image processing operation on a captured image generated in response to a photographing input, and a memory configured to provide a space required for the image processing operation of the processor, wherein the processor, when the photographing input is received, allocates a memory space required for the image processing operation based on expected photographing pattern data generated by a machine learning model.

According to another aspect of the inventive concept, there is provided a method of operating an electronic device including a processor configured to perform an image processing operation on a captured image generated by a photographing input and a memory configured to provide a space required for the image processing operation of the processor including generating photographing pattern data based on photographed data, training a machine learning model by using the photographing pattern data, generating expected photographing pattern data by using the machine learning model, receiving a photographing input, and allocating a memory space required for the image processing operation based on the expected photographing pattern data.

According to another aspect of the inventive concept, there is provided an electronic device including an input module receiving a photographing input from a user, a camera module configured to generate a captured image when the photographing input is received, a processor configured to perform an image processing operation on the captured image, and a memory configured to provide a space required for the image processing operation of the processor, wherein the processor, when the photographing input is received, allocates a memory space required for the image processing operation based on expected photographing pattern data generated by a machine learning model.

### BRIEF DESCRIPTION OF THE DRAWINGS

Embodiments of the inventive concept will be more clearly understood from the following detailed description taken in conjunction with the accompanying drawings in which:

FIG. 1 is a block diagram of an electronic device according to an embodiment;

FIG. 2 is a diagram of a processor included in a memory controller according to an embodiment;

FIG. 3 is a diagram of photographing pattern data used by an electronic device according to an embodiment;

FIG. 4 is a diagram of an example of expected photographing pattern used by an electronic device, according to an embodiment;

FIG. 5 is a diagram of an example of memory allocation of an electronic device, according to an embodiment;

FIG. 6 is a flowchart of a method of operating an electronic device, according to an embodiment;

FIG. 7 is a flowchart of a method of operating an electronic device to generate photographing pattern data, according to an embodiment;

FIG. 8 is a flowchart of a method of operating an electronic device to allocate a memory space based on expected photographing pattern, according to an embodiment;

FIG. 9 is a flowchart of a method of operating an electronic device after receiving a subsequent photographing input, according to an embodiment; and

FIG. 10 is a block diagram of a network environment including an electronic device, according to an embodiment.

### DETAILED DESCRIPTION OF THE EMBODIMENTS

Hereinafter, embodiments of the inventive concept will be described in detail with reference to the accompanying drawings.

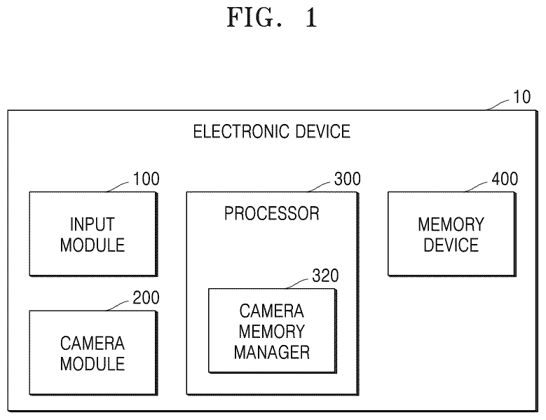

FIG. 1 is a block diagram of an electronic device 10 according to an embodiment.

Referring to FIG. 1, the electronic device 10 according to an embodiment may include an input module 100, a camera module 200, a processor 300, and a memory device 400.

In the embodiment, the electronic device 10 may include a device supporting a photographing function, and may include any one of a smartphone, a tablet personal computer (PC), a smart TV, a mobile phone, a personal digital assistant (PDA), a laptop, a digital broadcasting terminal, a kiosk, an MP3 player, a digital camera, a home appliance, other mobile or non-mobile computing devices, or the like, but the embodiment is not limited thereto. In addition, the electronic device 10 may include a wearable device, such as a watch, glasses, a hairband, and a ring with a photographing function. However, the embodiment is not limited thereto, and the electronic device 10 may include all types of devices that photograph an object and generate captured images. In addition, the electronic device 10 may include a device that supports a photographing function, such as a vehicle.

The input module 100 may receive various types of inputs for controlling an operation of the electronic device 10 from a user. For example, the input module 100 may be implemented as a touch screen display that receives a touch input from a user in various methods, such as a decompression method and a capacitive method.

The input module 100 may receive a photographing input from a user. The photographing input may include an input for allowing the electronic device 10 to photograph an object and generate a captured image.

The camera module 200 may generate a captured image by photographing an object. For example, the camera module 200 may generate a captured image by collecting light emitted by an object and converting the collected light into an electrical signal. The camera module 200 may include a lens assembly, a flash, an image sensor, etc.

When receiving a photographing input from a user via the input module 100, the camera module 200 may generate a captured image.

The processor 300 may control the entire operation of the electronic device 10. For example, the processor 300 may include any one of devices capable of performing management operations on the memory device 400, such as an application processor (AP), a central processing unit (CPU), and a microprocessor.

The processor 300 may perform various types of image processing on the captured image. When receiving a photographing input via the input module 100, the processor 300 may allocate a memory space required for an image processing operation based on expected photographing pattern data generated by using a machine learning model.

In the embodiment, the processor 300 may include a camera memory manager 320. The camera memory manager 320 may generate photographing pattern data based on photographed data corresponding to a photographing input, and generate expected photographing pattern data based on the photographing pattern data. The expected photographing pattern data may be used to allocate a memory space inside the memory device 400 that is used by the processor 300.

By allocating at an appropriate time point a memory space required for an image processing operation based on the expected photographing pattern data generated by the camera memory manager 320, the processor 300 may efficiently use the memory device 400.

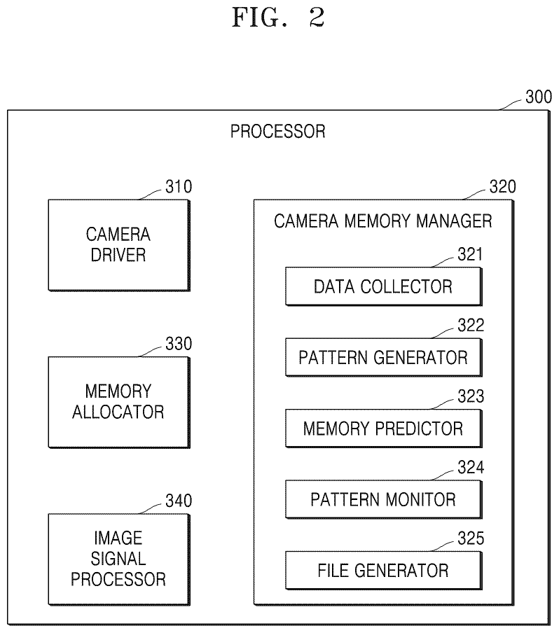

Descriptions of the operation of the camera memory manager 320 are given below with reference to FIG. 2 and subsequent drawings.

The memory device 400 may store data used by the processor 300. For example, the memory device 400 may include a volatile memory, such as static random access memory (RAM) (SRAM) and dynamic RAM (DRAM).

The memory device 400 may provide a space required for an image processing operation of the processor 300. In this case, the space provided by the memory device 400 may be referred to as a memory space.

FIG. 2 is a diagram of the processor 300 included in the electronic device 10 according to an embodiment.

Referring to FIG. 2, the processor 300 included in the electronic device 10 according to an embodiment may include a camera driver 310, the camera memory manager 320, a memory allocator 330, and an image signal processor 340. In the embodiment of FIG. 2, for convenience of description, the operation of internal components of the processor 300 may be divided into an operation of each of the camera driver 310, the camera memory manager 320, the memory allocator 330, and the image signal processor 340, but the embodiment is not limited thereto.

The camera driver 310 may control the entire operation of the camera module 200. When receiving a photographing input via the input module 100, the camera driver 310 may transmit a photograph request to the camera module 200. In this case, the camera module 200 may generate a captured image in response to the photograph request.

The camera memory manager 320 may generate data to be used for allocating and releasing a memory space required for the image processing operation of a captured image generated by using the camera module 200.

The camera memory manager 320 may include a data collector 321, a pattern generator 322, and a memory predictor 323.

The data collector 321 may generate the photographed data corresponding to the photographing input received from the input module 100. Photographed data may include data on a photographing operation corresponding to a photographing input, and may include information about the photographing input that is input by a user and information about a memory space used for an image processing operation of a captured image generated according to the photographing input.

In an embodiment, the photographed data may include memory usage data for each of a photographing mode, a photographing time point, a photographing type, and an image processing operation. The photographing mode may include information about how to set resolution, illuminance, or the like, and how to perform photographing. For example, the photographing mode may include a normal mode, a high-resolution mode, a night mode, etc. The photographing time point may include information about a time point at which a user applies the photographing input via the input module 100. The photographing type may include information about how to perform photographing among single photographing and continuous photographing. In this case, the continuous photographing may be referred to as the photographing continuously performed at a short time interval (for example, about 0.3 seconds). The memory usage for each image processing operation may include information about how much the capacity of the memory device 400 is used when the image signal processor 340 performs each image processing operation on the captured image.

The pattern generator 322 may generate the photographing pattern data based on the photographed data. The photographing pattern data may include data representing a photographing pattern of a user. In this case, the photographing pattern may indicate a method how a photographing input is applied by a user, and the photographing pattern may include information about when and how the photographing has been performed. In other words, the photographing pattern data may include data that indicates how a photographing input for requesting photographing from a user has been applied with a uniform period, and how the memory space has been used for the image processing operation on the captured image generated according to the photographing input.

The pattern generator 322 may convert a photographing time point included in the photographed data into a form of a relative time. The photographing time point included in the photographed data generated by the data collector 321 may be in the form of a time stamp, and for example, may have a value such as about 427423.256. The pattern generator 322 may convert the photographing time point into a form of a relative time representing the time difference between photographing time points of each of the pieces of photographed data. For example, the pattern generator 322 may convert the photographing time point into a form of a relative time representing the time difference between photographing time points, such as T, T+2, and T+3.

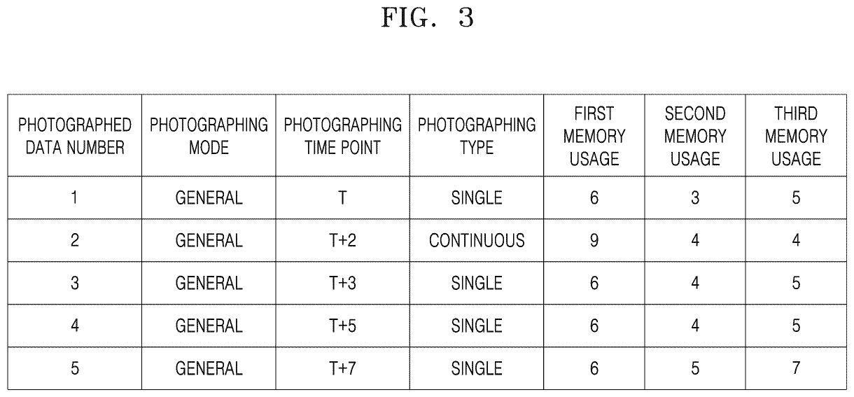

The pattern generator 322 may generate photographing pattern data based on the photographing time point that has been converted into the form of the relative time. Firstly, the pattern generator 322 may arrange the photographed data in the order of the photographing time point that has been converted into the form of the relative time. Thereafter, when the photographing modes of adjacent pieces of photographed data are the same, and the difference in the photographing time points between the adjacent pieces of photographed data is within a reference interval, the pattern generator 322 may include the adjacent pieces of photographed data in the same photographing pattern data. An example of the photographing pattern data generated by the pattern generator 322 may be described with reference to FIG. 3.

FIG. 3 is a diagram of the photographing pattern data used by the electronic device 10 according to an embodiment.

Referring to FIG. 3, as an example, five pieces of photographed data having photographed data numbers of 1 through 5 are included in one piece of photographing pattern data. Hereinafter, the five pieces of photographed data respectively having photographed data numbers of 1 through 5 may be respectively referred to as first through fifth pieces of photographed data.

The photographing pattern data may include information about each of the first through fifth pieces of photographed data. As in the embodiment of FIG. 3, the photographing pattern data may include the photographing mode, the photographing time point, a photographing type, and memory usage for each of the image processing operations, which are included in each of the first through fifth pieces of photographed data.

The pattern generator 322 may include photographed data having the same photographing mode in the same photographing pattern data. Accordingly, in the embodiment of FIG. 3, the photographing mode of each of the first through fifth pieces of photographed data may be the same as a normal mode.

The pattern generator 322 may include photographed data in which the difference between the photographing time points of adjacent pieces of photographed data is within a reference interval (for example, 5), in the same photographing pattern data. In the embodiment of FIG. 3, the difference between the photographing time points of the first and second pieces of photographed data may be 2, which may be within the reference interval. In addition, the difference between the photographing time points of the second and third pieces of photographed data may be 1, the difference between the photographing time points of the third and fourth pieces of photographed data may be 2, and the difference between the photographing time points of the fourth and fifth pieces of photographed data may be 2, all of which may be within the reference interval.

The photographing types of respective pieces of photographed data included in the photographing pattern data may be different. In the embodiment of FIG. 3, the photographing type of the second piece of photographed data may be the continuous photographing, and the photographing type of the remaining pieces of photographed data excluding the second piece of photographed data may be the single photographing.

The photographing pattern data may include memory usage for each image processing operation. In the embodiment of FIG. 3, a first memory usage may represent the capacity of the memory space used when the image signal processor 340 has performed a first image processing operation, a second memory usage may represent the capacity of the memory space used when the image signal processor 340 has performed a second image processing operation, and a third memory usage may represent the capacity of the memory space used when the image signal processor 340 has performed a third image processing operation.

Referring back to FIG. 2 again, the memory predictor 323 may generate the expected photographing pattern data based on the photographing pattern data.

The memory predictor 323 may include a machine learning model. The memory predictor 323 may generate the expected photographing pattern data based on the photographing pattern data by using the machine learning model. For example, the machine learning model may include any one of models, such as a convolutional neural network (CNN), a recurrent neural network (RNN), and a transformer.

The memory predictor 323 may train the machine learning model by using the photographing pattern data. The memory predictor 323 may train the machine learning model by inputting the photographing pattern data to the machine learning model. The memory predictor 323 may generate the expected photographing pattern data by using the machine learning model.

The expected photographing pattern data may include data to expect the pattern of a subsequent photographing input received from the user. In other words, when the photographing input is received from the user via the input module 100, the expected photographing pattern data may include data to expect, in which pattern the subsequent photographing input is applied by the user, and how the memory space used for the image processing operation of the captured image generated according to the subsequent photographing input is to be used.

The expected photographing pattern data may include one or more expected photographing patterns for each photographing mode. For example, when the photographing modes include the normal mode, a high-resolution mode, and the night mode, the expected photographing pattern data may include one or more expected photographing patterns for the normal mode, one or more expected photographing patterns for the high-resolution mode, and one or more expected photographing patterns for the night mode.

The expected photographing pattern data may include a probability corresponding to each of one or more expected photographing patterns for each photographing mode. For example, when the expected photographing pattern data includes first through third expected photographing patterns for the normal mode, the expected photographing pattern may include a first probability, which is the probability of occurrence of the first expected photographing pattern in the normal mode, a second probability, which is the probability of occurrence of the second expected photographing pattern in the normal mode, a third probability, which is the probability of occurrence of the third expected photographing pattern in the normal mode, and in this case, the sum of the first through third probabilities may be about 100%.

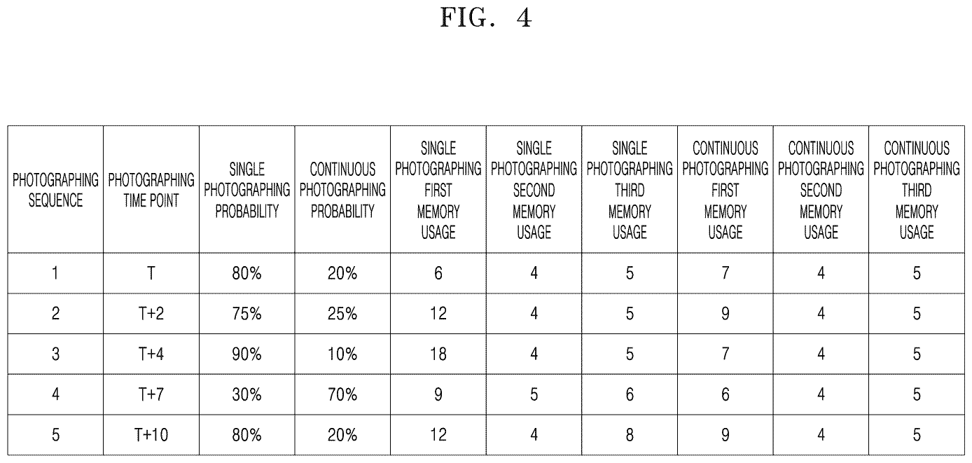

Each of one or more expected photographing patterns for each photographing mode included in the expected photographing pattern data may include an expected time point of a subsequent photographing input, an expected probability of a photographing type of the subsequent photographing input, and an expected memory usage for each image processing operation. An example of the expected photographing pattern may be described with reference to FIG. 4.

FIG. 4 is a diagram of an example of the expected photographing pattern used by the electronic device 10, according to an embodiment.

Referring to FIG. 4, as an example, expectations for five photographing inputs having a photographing order of 1 through 5 are included in the expected photographing pattern. Hereinafter, each of expectations for the five photographing inputs having the photographing order of 1 through 5 may be referred to as first through fifth pieces of expected photographed data.

The expected photographing pattern may include information about each of the first through fifth pieces of expected photographed data.

The photographing time point of the table of FIG. 4 may indicate an expected time point of a subsequent photographing input. In the table of FIG. 4, it may be identified that the photographing inputs are expected to be input at the time points T, T+2, T+4, T+7, and T+10, e.g., at the photographing time points of the first through fifth pieces of expected photographed data.

The single photographing probability and the continuous photographing probability in the table of FIG. 4 may indicate expected probabilities of the photographing types of the subsequent photographing inputs. In the table of FIG. 4, it may be identified that like the single photographing probability and the continuous photographing probability of the first piece of expected photographed data, the probability of the single photographing being performed at the time point T is about 80% and the probability of the continuous photographing being performed at the time point T is about 20%. It may be identified that like the single photographing probability and the continuous photographing probability of the second piece of expected photographed data, the probability of the single photographing being performed at the time point T+2 is about 75 % and the probability of the continuous photographing being performed at the time point T is about 25%. It may be identified that like the single photographing probability and the continuous photographing probability of the third piece of expected photographed data, the probability of the single photographing being performed at the time point T+4 is about 90% and the probability of the continuous photographing being performed at the time point T+4 is about 10%. It may be identified that like the single photographing probability and the continuous photographing probability of the fourth piece of expected photographed data, the probability of the single photographing being performed at the time point T+7 is about 30% and the probability of the continuous photographing being performed at the time point T+7 is about 70%. It may be identified that like the single photographing probability and the continuous photographing probability of the fifth piece of expected photographed data, the probability of the single photographing being performed at the time point T+10 is about 80% and the probability of the continuous photographing being performed at the time point T+10 is about 20%.

First through third memory usages for the single photographing and first through third memory usages for the continuous photographing in the table of FIG. 4 may indicate expected memory usage for each image processing operation on the captured image generated by a subsequent photographing input.

In the table of FIG. 4, it may be identified that when first through third memory usages are for the single photographing of the first piece of expected photographed data, the single photographing is performed at the time point T, the first memory usage is expected to be about 6, the second memory usage is expected to be about 4, and the third memory usage is expected to be about 5. In addition, it may be identified that when first through third memory usages are for the continuous photographing of the first piece of expected photographed data, the continuous photographing is performed at the time point T, the first memory usage is expected to be about 7, the second memory usage is expected to be about 4, and the third memory usage is expected to be about 5.

In addition, it may be identified that when first through third memory usages are for the single photographing of the second piece of expected photographed data, the single photographing is performed at the time point T+2, the first memory usage is expected to be about 12, the second memory usage is expected to be about 4, and the third memory usage is expected to be about 5. In addition, it may be identified that when first through third memory usages are for the continuous photographing of the second piece of expected photographed data, the continuous photographing is performed at the time point T+2, the first memory usage is expected to be about 9, the second memory usage is expected to be about 4, and the third memory usage is expected to be about 5.

In addition, it may be identified that when first through third memory usages are for the single photographing of the third piece of expected photographed data, the single photographing is performed at the time point T+4, the first memory usage is expected to be about 18, the second memory usage is expected to be about 4, and the third memory usage is expected to be about 5. In addition, it may be identified that when first through third memory usages are for the continuous photographing of the third piece of expected photographed data, the continuous photographing is performed at the time point T+4, the first memory usage is expected to be about 7, the second memory usage is expected to be about 4, and the third memory usage is expected to be about 5.

In addition, it may be identified that when first through third memory usages are for the single photographing of the fourth piece of expected photographed data, the single photographing is performed at the time point T+7, the first memory usage is expected to be about 9, the second memory usage is expected to be about 5, and the third memory usage is expected to be about 6. In addition, it may be identified that when first through third memory usages are for the continuous photographing of the fourth piece of expected photographed data, the continuous photographing is performed at the time point T+7, the first memory usage is expected to be about 6, the second memory usage is expected to be about 4, and the third memory usage is expected to be about 5.

In addition, it may be identified that when first through third memory usages are for the single photographing of the fifth piece of expected photographed data, the single photographing is performed at the time point T+10, the first memory usage is expected to be about 12, the second memory usage is expected to be about 4, and the third memory usage is expected to be about 8. In addition, it may be identified that when first through third memory usages are for the continuous photographing of the fifth piece of expected photographed data, the continuous photographing is performed at the time point T+10, the first memory usage is expected to be about 9, the second memory usage is expected to be about 4, and the third memory usage is expected to be about 5.

Referring back to FIG. 2 again, the memory predictor 323 may train the machine learning model by using the photographing pattern data after the photographing operation of the electronic device 10 has ended. In an embodiment, the completion of the photographing operation may mean the completion of an operation of generating the captured image by using the camera module 200. In addition, in another embodiment, the completion of the photographing operation may mean the completion of operating an application using the camera module 200. By training the machine learning model after the photographing operation of the electronic device 10 has ended, the memory predictor 323 may prevent the performance of the photographing operation of the memory predictor 323 from decreasing due to the learning of the machine learning model.

The memory allocator 330 may determine allocation and release of the memory space inside the memory device 400 required for the image processing operation of the captured image by using the image signal processor 340. The camera memory manager 320 may determine the allocation of the memory space corresponding to the size required for the image processing operation before performing the image processing operation.

The memory allocator 330 may allocate the memory space required for the image processing operation based on the expected photographing pattern data. When the photographing input is received, the memory allocator 330 may select the expected photographing pattern having the highest probability among one or more expected photographing patterns for the photographing mode of the photographing input from the expected photographing pattern data. For example, when the photographing input in the normal mode is received via the input module 100, the memory allocator 330 may select the expected photographing pattern having the highest probability among one or more expected photographing patterns for the normal mode included in the expected photographing pattern data. For example, when the first probability, which is the occurrence probability of the first expected photographing pattern for the normal mode, is about 60%, the second probability, which is the occurrence probability of the second expected photographing pattern for the normal mode, is about 25%, and the third probability, which is the occurrence probability of the third expected photographing pattern for the normal mode, is about 15%, the memory allocator 330 may select the first expected photographing pattern for the normal mode.

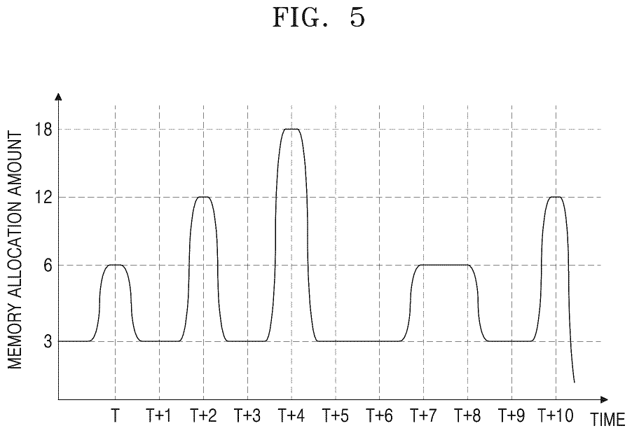

The memory allocator 330 may allocate the memory space required for the image processing operation based on the selected expected photographing pattern. The memory allocator 330 may allocate the memory space corresponding to the expected memory usage for each image processing operation corresponding to the photographing type that is highly likely at the expected time point of the subsequent photographing input included in the expected photographing pattern. A detailed example in which the memory allocator 330 allocates the memory space based on the expected photographing pattern is described below with reference to FIG. 5.

In the embodiment, the memory allocator 330 may allocate the memory space corresponding to the expected memory usage at a time point earlier than the expected time point of the subsequent photographing input by using the reference time. For example, when the expected time point of the subsequent photographing input is T+2 and the reference time is 0.5, the memory allocator 330 may allocate the memory space corresponding to the expected memory usage at a time point T+0.5.

In another embodiment, the memory allocator 330 may allocate the memory space corresponding to a reference allocation rate of the expected memory usage at a time point earlier than the expected time point of the subsequent photographing input by the reference time. The reference allocation rate may be a rate at which the memory space is to be allocated by the memory allocator 330 in advance before the expected time point by the reference time. For example, when the expected time point of the subsequent photographing input is T+2, the reference time is 0.5, and the reference allocation rate is about 50%, the memory allocator 330 may allocate the memory space corresponding to about 50% of the expected memory usage at a time point T+0.5. In this manner, by allocating the memory space corresponding to the reference allocation rate of the expected memory usage before the reference time point, even though the photographing input is received at a time point earlier than the expected time point via the input module 100, the memory allocator 330 may smoothly allocate the memory space.

In addition, the memory allocator 330 may determine whether to release the allocated memory space based on the expected time point of the subsequent photographing input.

In the embodiment, when the difference between the expected time points of the subsequent photographing inputs is greater than a reference difference, the memory allocator 330 may release the allocated memory space. For example, when the expected time points of the subsequent photographing inputs are T+4 and T+7, and the reference difference is 0.5, the memory allocator 330 may determine that the memory space is to be released after the time point T+4 (for example, at a time point T+4.5). Thereafter, the memory allocator 330 may allocate the memory space again at a time point T+6.5 that is earlier than the expected time point T+7 of the subsequent photographing input by the reference time. In this manner, when the memory space is expected not to be used for a time longer than the reference difference, the memory allocator 330 may increase the efficiency of memory usage by releasing the memory space.

When the photographing type expected at the expected time point of the subsequent photographing input is the continuous photographing, the memory allocator 330 may maintain the allocated memory space until the continuous photographing is ended. In other words, when the continuous photographing probability at the expected time point of the subsequent photographing input is greater than the single photographing probability, the memory allocator 330 may maintain the allocated memory space until the continuous photographing probability is ended. In this case, by increasing a maintaining time during which the allocated memory space is maintained until released, in the continuous photographing, the memory allocator 330 may maintain the allocated memory space until the continuous photographing is ended.

In the embodiment, when the expected time point of the subsequent photographing input is T+7, and the photographing type having a high probability at the time point T+7 is the continuous photographing, the memory allocator 330 may maintain the allocated memory until the continuous photographing is ended. In this manner, by reducing repeated memory allocations and release operations, which may occur during the continuous photographing, the performance degradation of the electronic device 10 due to the repeated memory allocations and release operations may be prevented, and accordingly, the captured image generated by the continuous photographing may be processed at a relatively fast speed.

In another embodiment, when the difference between the expected time points of the subsequent photographing inputs is greater than a reference difference, the memory allocator 330 may release the allocated memory space step-by-step based on the reference release rate. The reference release rate may be a rate at which the allocated memory space is to be released when the memory allocator 330 releases the memory space step-by-step. For example, when the expected time points of the subsequent photographing inputs are T+4 and T+7, the reference difference is 0.5, the memory space allocated at the time point T+4 is 8, and the reference release rate is about 50%, the memory allocator 330 may determine to release firstly 4, which is about 50% of the memory space allocated after the time point T+4 (for example, a time point T+4.5), release 2, which is about 50% of the remaining allocated memory space after a first delay time (for example, 0.5) (for example, at the time point T+5), and release 2, which is the remaining allocated memory space after a second delay time (for example, 0.4) (for example, at the time point T+5.4). In this case, the first delay time and the second delay time may be variable times in which a preset or predicted time, during which the memory allocator 330 further maintains the memory space without releasing the memory space, is taken into account. In the example described above, the case in which the memory allocator 330 releases the allocated memory space step-by-step in three steps has been described, but unlike the example described above, the memory allocator 330 may release the memory space step-by-step in two or four or more steps. In this manner, by releasing the allocated memory space step-by-step based on the reference release rate, the memory allocator 330 may smoothly allocate the memory space even when receiving the photographing input at a time point that is different from the expected time point via the input module 100.

The image signal processor 340 may perform various types of image processing operations on the captured image generated in response to the photographing input. The image signal processor 340 may perform various types of image processing operations by using the memory space in the memory device 400 allocated by the memory allocator 330.

The camera memory manager 320 may further include a pattern monitor 324 and a file generator 325.

The pattern monitor 324 may monitor reception of the subsequent photographing input after the memory space is allocated, based on the expected photographing pattern, by the memory allocator 330. The pattern monitor 324 may determine whether the reception time point of the subsequent photographing input matches the expected time point of the subsequent photographing input of the expected photographing pattern. In this case, although the reception time point of the subsequent photographing input does not completely match the expected time point of the subsequent photographing input of the expected photographing pattern, when the difference therebetween is within the reference time difference, the pattern monitor 324 may determine that the reception time point of the subsequent photographing input matches the expected time point of the subsequent photographing input of the expected photographing pattern.

When the expected time point of the subsequent photographing input of the expected photographing pattern does not match the reception time point of the subsequent photographing input, the pattern monitor 324 may change the expected photographing pattern to an expected photographing pattern having a next high probability among one or more expected photographing patterns for the photographing mode of the photographing input in the expected photographing pattern data. For example, in a state in which the first expected photographing pattern for the normal mode is selected, when the expected time point of the subsequent photographing input of the expected photographing pattern does not match the reception time point of the subsequent photographing input, the pattern monitor 324 may change the expected photographing pattern to another expected photographing pattern for the normal mode. For example, when the second probability, which is the occurrence probability of the second expected photographing pattern for the normal mode, is about 25%, and the third probability, which is the occurrence probability of the third expected photographing pattern for the normal mode, is about 15%, the memory allocator 330 may change the expected photographing pattern to the second expected photographing pattern for the normal mode.

After the memory space is allocated based on the expected photographing pattern by the memory allocator 330, the pattern monitor 324 may monitor the memory usage for each image processing operation of the subsequent photographing input. The pattern monitor 324 may determine whether an error between the expected memory usage for each image processing operation of the expected photographing pattern and the memory usage for each image processing operation of the subsequent photographing input is greater than a reference error.

When the error between the expected memory usage for each image processing operation of the expected photographing pattern and the memory usage for each image processing operation of the subsequent photographing input is greater than the reference error, the pattern monitor 324 may retrain the machine learning model based on the photographed data corresponding to the subsequent photographing input.

The file generator 325 may generate information about the machine learning model and a user-customized file based on the expected photographing pattern data. The user-customized file may include a result, of learning by using the machine learning model, that shows which pattern has been used for photographing by the user by using the electronic device 10. The file generator 325 may generate the user-customized file to include the expected photographing pattern data, the photographed data used for training the machine learning model, patterns and rule data learned by the machine learning model, etc. The user-customized file generated by the file generator 325 may be transmitted to another electronic device outside the electronic device 10, and even when the user photographs by using another electronic device, the user-customized file may give to the user the same feeling that the user performs photographing in the same environment as that by using the existing electronic device 10.

FIG. 5 is a diagram of an example of memory allocation of the electronic device 10, according to an embodiment.

Referring to FIG. 5, as an example, the memory allocator 330 has performed the memory allocation corresponding to the first memory usage, based on the expected photographing pattern as illustrated in FIG. 4.

Referring to the expected photographing pattern in FIG. 4 together with the example in FIG. 5, firstly, it may be identified that the single photographing probability at the time point T is about 80%, which is greater than the continuous photographing probability of about 20%. Accordingly, the memory allocator 330 may allocate a total of 6 memory spaces that is the first memory usage for the single photographing at the time point T.

Next, it may be identified that the single photographing probability at the time point T+2 is about 75%, which is greater than the continuous photographing probability of about 25%. Accordingly, the memory allocator 330 may allocate a total of 12 memory spaces that is the first memory usage for the single photographing at the time point T+2.

Next, it may be identified that the single photographing probability at the time point T+4 is about 90%, which is greater than the continuous photographing probability of about 10%. Accordingly, the memory allocator 330 may allocate a total of 18 memory spaces that is the first memory usage for the single photographing at the time point T+4.

Next, it may be identified that the single photographing probability at the time point T+7 is about 70%, which is greater than the continuous photographing probability of about 30%. Accordingly, the memory allocator 330 may allocate a total of 6 memory spaces that is the first memory usage for the single photographing at the time point T+7.

Finally, it may be identified that the single photographing probability at the time point T+10 is about 80%, which is greater than the continuous photographing probability of about 20%. Accordingly, the memory allocator 330 may allocate a total of 12 memory spaces that is the first memory usage for the single photographing at the time point T+10.

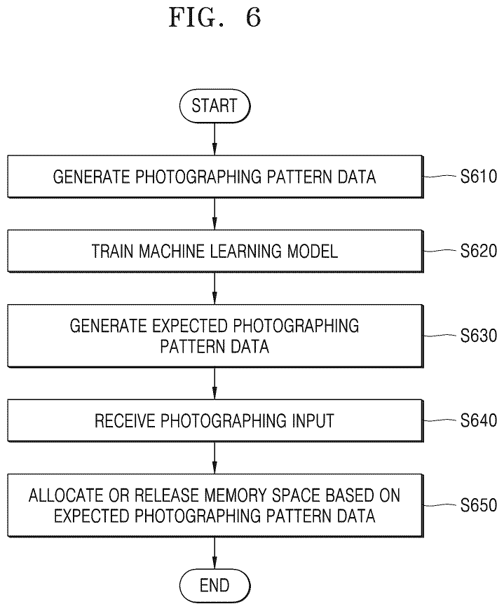

FIG. 6 is a flowchart of a method of operating the electronic device 10, according to an embodiment.

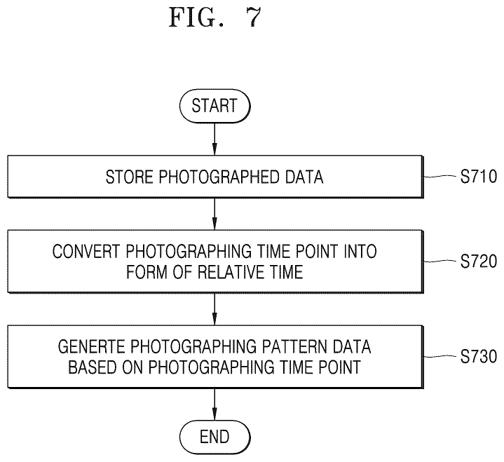

Referring to FIG. 6, in operation S610, the electronic device 10 may generate the photographing pattern data based on the photographed data by using the processor 300. The processor 300 may generate the photographing pattern data by using the method illustrated in FIG. 7.

FIG. 7 is a flowchart of a method of operating the electronic device 10 to generate the photographing pattern data, according to an embodiment.

Referring to FIG. 7, in operation S710, the processor 300 may store the photographed data. The processor 300 may store the photographed data generated in response to the photographing input that has been previously received.

In operation S720, the processor 300 may convert the photographing time point into a form of a relative time. The processor 300 may convert the photographing time point included in each piece of the photographed data (for example, 427423.256, 427424.989, 427426.422, . . . ) into a form of the relative time (for example, T, T+1, T+2, . . . ).

In operation S730, the processor 300 may generate the photographing pattern data based on the photographing time point. The processor 300 may generate the photographing pattern data, by arranging the photographed data in a sequence of the photographing time points converted into a form of the relative time, and when the photographing modes of adjacent pieces of photographed data are the same and the difference between the photographing time points of adjacent pieces of photographed data is within the reference interval, by including the photographed data in the same photographing pattern data.

Returning back to FIG. 6 again, after the photographing pattern data is generated in operation S610, in operation S620, the electronic device 10 may train the machine learning model by using the processor 300. The processor 300 may train the machine learning model by inputting the photographing pattern data to the machine learning model.

In operation S630, the electronic device 10 may generate the expected photographing pattern data by using the processor 300. The processor 300 may generate the expected photographing pattern data by using the machine learning model that has learned in operation S620.

In operation S640, the electronic device 10 may receive the photographing input by using the input module 100. In response to the photographing input, the electronic device 10 may generate a captured image by using the camera module 200.

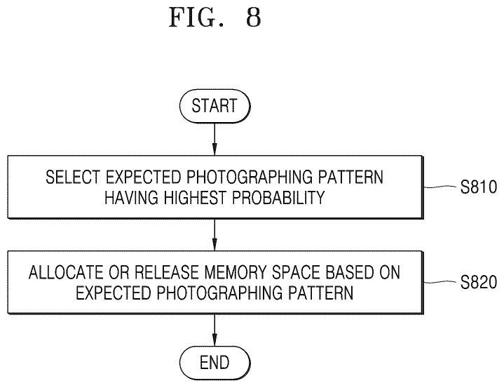

In operation S650, the electronic device 10 may allocate or release the memory space based on the expected photographing pattern data by using the processor 300. The processor 300 may allocate or release the memory space by using the method as illustrated in FIG. 8.

FIG. 8 is a flowchart of a method of operating the electronic device 10 to allocate the memory space based on the expected photographing pattern, according to an embodiment.

Referring to FIG. 8, in operation S810, the processor 300 may select an expected photographing pattern having the highest probability. The processor 300 may select the expected photographing pattern having the highest probability among one or more expected photographing patterns for the photographing mode of the photographing input from the expected photographing pattern data generated in operation S630.

In operation S820, the processor 300 may allocate or release the memory space based on the expected photographing pattern. The processor 300 may allocate the memory space corresponding to the expected memory usage for each image processing operation corresponding to the photographing type that is highly likely at the expected time point of the subsequent photographing input included in the expected photographing pattern. In addition, when the difference between the expected time points of the subsequent photographing inputs is greater than the reference difference, the processor 300 may release the allocated memory space.

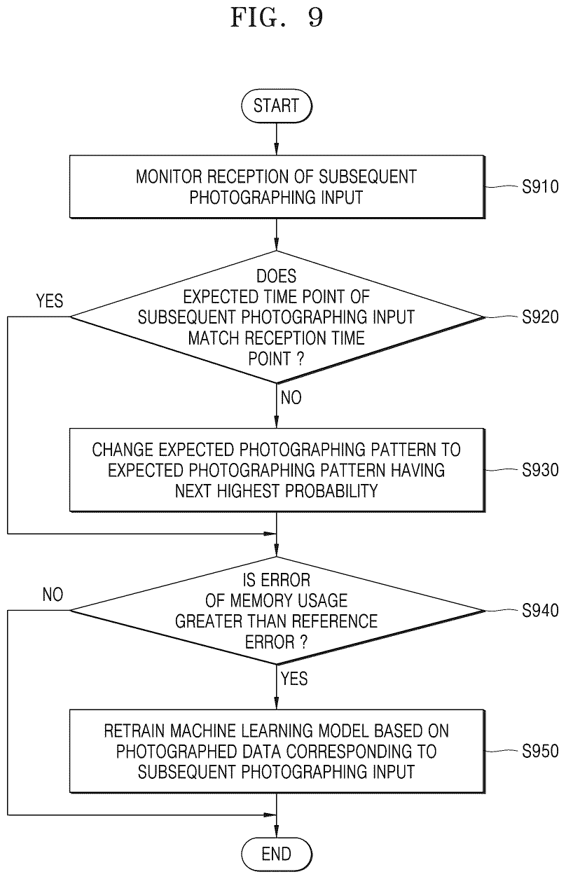

FIG. 9 is a flowchart of a method of operating the electronic device 10 after receiving the subsequent photographing input, according to an embodiment.

Referring to FIG. 9, examples of operations that may be performed after operation S650 in FIG. 6 may be identified.

In operation S910, the processor 300 may monitor reception of the subsequent photographing input. After receiving the photographing input in operation S640, the processor 300 may monitor at which time point the subsequent photographing input is received. In addition, the processor 300 may monitor how much memory space has been used according to the reception of the subsequent photographing input.

In operation S920, the processor 300 may determine whether the expected time point of the subsequent photographing input matches the reception time point of the subsequent photographing input.

When the expected time point of the subsequent photographing input does not match the reception time point of the subsequent photographing input, the process may proceed to operation S930, and the processor 300 may change the expected photographing pattern to an expected photographing pattern having the next high probability among one or more expected photographing patterns for the photographing mode of the photographing input out of the expected photographing pattern data.

When the expected time point of the subsequent photographing input matches the reception time point of the subsequent photographing input, operation S930 may be omitted, and the process may proceed to operation S940.

In operation S940, the processor 300 may determine whether an error in the memory usage is greater than the reference error. The processor 300 may determine whether an error between the expected memory usage for each image processing operation of the expected photographing pattern and the memory usage for each image processing operation of the subsequent photographing input is greater than the reference error.

When the error of the memory usage is greater than the reference error, the process may proceed to operation S950, and the processor 300 may retrain the machine learning model based on the photographed data corresponding to the subsequent photographing input.

When the error of the memory usage is not greater than the reference error, operation S950 may be omitted, and the operation may be ended.

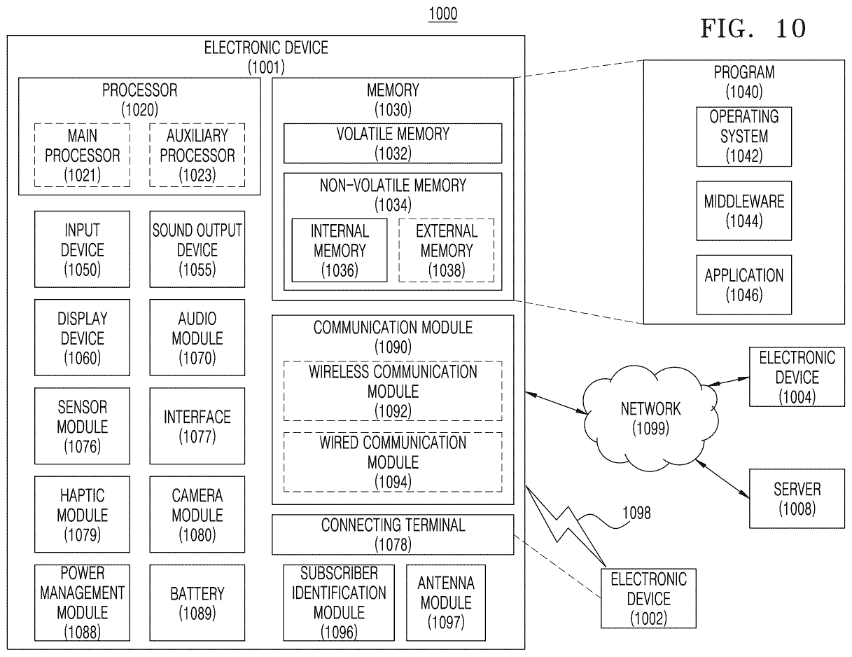

FIG. 10 is a block diagram of a network environment 1000 including an electronic device 1001, according to an embodiment.

Referring to FIG. 10, the electronic device 1001 in the network environment 1000 (for example, a base station (BS) or user equipment (UE)) may communicate with an electronic device 1002 (for example, a BS or UE) via a first network 1098 (for example, a short-distance wireless communication network), or may communicate with an electronic device 1004 (for example, a BS or UE) or a server 1008 (for example, a BS or UE) via a second network 1099 (for example, a long-distance wireless communication network). The electronic device 1001 may communicate with the electronic device 1004 via the server 1008. The electronic device 1001 may include a processor 1020, a memory 1030, an input device 1050, a sound output device 1055, a display device 1060, an audio module 1070, a sensor module 1076, an interface 1077, a haptic module 1079, a camera module 1080, a power management module 1088, a battery 1089, a communication module 1090, a subscriber identity module (SIM) card 1096, or an antenna module 1097. In an embodiment, at least one component (for example, the display device 1060 or the camera module 1080) may be omitted from the electronic device 1001, or one or more other components may be added to the electronic device 1001. Some of the components may be implemented as a single integrated circuit (IC). For example, the sensor module 1076 (for example, a fingerprint sensor, an iris sensor, or an illuminance sensor) may be embedded in the display device 1060 (for example, a display).

The processor 1020 may execute software (for example, a program 1040) for controlling at least one other components (for example, hardware or software components) of the electronic device 1001, coupled to the processor 1020, and may perform various data processing operations or calculation operations.

As at least portions of data processing operations or calculation operations, the processor 1020 may load a command or data received from another component (for example, the sensor module 1076 or the communication module 1090) onto a volatile memory 1032, process the stored command or data, store the processed stored command or data in the volatile memory 1032, and store the result data in a non-volatile memory 1034. The processor 1020 may include a main processor 1021 (for example, a CPU or an AP), and an auxiliary processor 1023 capable of operating independently of or together with the main processor 1021 (for example, a graphics processing unit (GPU), an image signal processor (ISP), a sensor hub processor, or a communication processor (CP)). Additionally, or selectively, the auxiliary processor 1023 may be applied to consume less power than the main processor 1021, or perform a particular function. The auxiliary processor 1023 may be implemented separately from the main processor 1021, or may be implemented as a portion of the main processor 1021.

The auxiliary processor 1023 may control at least some of the functions or states associated with at least one of the components of the electronic device 1001 (for example, the display device 1060, the sensor module 1076, or the communication module 1090), instead of the main processor 1021 when the main processor 1021 is in an inactive (for example, sleep) state, or together with the main processor 1021 when the main processor 1021 is in an active state (for example, executing an application). The auxiliary processor 1023 (for example, an ISP or a CP) may be implemented as another component functionally related to the auxiliary processor 1023 (for example, the camera module 1080 or the communication module 1090).

The processor 1020 illustrated in FIG. 10 may perform an operation corresponding to the processor 300 according to the embodiments described above with reference to FIGS. 1 through 9. For example, the processor 1020 illustrated in FIG. 10 may allocate a memory space required for the image processing operation based on the expected photographing pattern generated by the machine learning model in response to the photographing input. As a result, a memory device may be efficiently used by allocating a memory space at an appropriate time point.

The memory 1030 may store various pieces of data used in at least one component of the electronic device 1001 (for example, the processor 1020 or the sensor module 1076). Various pieces of data may include, for example, input data or output data for software (for example, the program 1040) and commands related to the software. The memory 1030 may include the volatile memory 1032 or the non-volatile memory 1034. The non-volatile memory 1034 may include an internal memory 1036 and/or an external memory 1038. The memory 1030 illustrated in FIG. 10 may correspond to the memory device 400 illustrated in FIG. 1.

The program 1040 may be stored in the memory 1030 as software, and may include, for example, an operating system (OS) 1042, middleware 1044, or an application 1046.

The input device 1050 may receive a command or data to be used by another component of the electronic device 1001 (for example, the processor 1020) from the outside (for example, a user) of the electronic device 1001. The input device 1050 may include, for example, a microphone, a mouse, or a keyboard. The input device 1050 illustrated in FIG. 10 may correspond to the input module 100 illustrated in FIG. 1.

The sound output device 1055 may output sound signals to the outside of the electronic device 1001. The sound output device 1055 may include, for example, a speaker or a receiver. A speaker may be used for general purposes of playing or recording multimedia, and a receiver may be used for telephone reception. The receiver may be implemented separately from the speaker, or may be implemented as a portion of the speaker.

The display device 1060 may visually provide information to the outside (for example, a user) of the electronic device 1001. The display device 1060 may include, for example, a display, a hologram device, or a projector, and may include a control circuit for controlling a corresponding device among the display, the hologram device, and the projector. The display device 1060 may include a touch circuit adapted to sense a touch, or a sensor circuit (for example, a pressure sensor) adapted to measure the strength of a force generated by the touch.

The audio module 1070 may convert sound into an electrical signal or vice versa. The audio module 1070 may obtain sound by using the input device 1050 or output sound by using the sound output device 1055 or a headphone of an electronic device 1002 outside the network environment 1000, coupled directly (for example, by wire) or wirelessly to the electronic device 1001.

The sensor module 1076 may detect an operation state (for example, power or temperature) of the electronic device 1001 or an environment state outside the electronic device 1001 (for example, a user state), and then generate an electrical signal or a data value corresponding to a subsequently detected state. The sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more particular protocols used by the electronic device 1001 to directly (for example, by wire) or wirelessly be coupled to the electronic device 1002 outside the network environment 1000. The interface 1077 may include, for example, a high-definition multimedia interface (HDMI), a universal serial bus (USB) interface, a secure digital (SD) card interface, or an audio interface.

A connecting terminal 1078 may include a connector capable of connecting physically the electronic device 1001 to the external electronic device 1002. The connecting terminal 1078 may include, for example, an HDMI connector, a USB connector, an SD card connector, or an audio connector (for example, a headphone connector).

The haptic module 1079 may convert an electrical signal into a mechanical stimulus (for example, vibration or movement) or an electrical stimulus that may be perceived by a user by using tactile sense or motion sense. The haptic module 1079 may include, for example, a motor, a piezoelectric element, or an electrical stimulation device.

The camera module 1080 may capture a still image or a video image. The camera module 1080 may include one or more lenses, image sensors, ISPs, or flashes. The power management module 1088 may manage power supplied to the electronic device 1001. The power management module 1088 may be implemented as at least a portion of, for example, a power management integrated circuit (PMIC). The camera module 1080 illustrated in FIG. 10 may correspond to the camera module 200 illustrated in FIG. 1.

The battery 1089 may supply power to at least one component of the electronic device 1001. The battery 1089 may include, for example, a non-rechargeable primary battery, a rechargeable secondary battery, or a fuel cell.

The communication module 1090 may support an establishment of a direct (for example, wired) communication channel or a wireless communication channel between the electronic device 1001 and an external electronic device (for example, the electronic device 1002, the electronic device 1004, or the server 1008), and may support performance of communication via the established communication channel. The communication module 1090 may include one or more communication processors capable of operating independently of the processor 1020 (for example, an AP) and supporting direct (for example, wired) communication or wireless communication. The communication module 1090 may include a wireless communication module 1092 (for example, a cellular communication module, a short-range wireless communication module, or a global navigation satellite system (GNSS) communication module) or a wired communication module 1094 (for example, a local area network (LAN) communication module or a power line communication (PLC) module). One of these communication modules may communicate with an external electronic device via a long-range communication network, such as the first network 1098 (for example, a short-range communication network, such as Bluetooth (trade mark ™), Wireless Fidelity (Wi-Fi) direct, and Infrared Data Association (IrDA)), and the second network 1099 (for example, a long-range communication network, such as a cellular network, the Internet, and a computer network (for example, a LAN or a wide area network (WAN))). Various forms of these communication modules may be implemented as one component (for example, a single IC), or may be implemented as a plurality of components (for example, multiple ICs) separated from each other. The wireless communication module 1092 may identify and authenticate the electronic device 1001 on a communication network, such as the first network 1098 and the second network 1099, by using subscriber information (for example, an international mobile subscriber identity (IMSI)) stored in the subscriber identification module 1096.

The antenna module 1097 may transceive a signal or power to and from the outside of the electronic device 1001 (for example, an external electronic device). The antenna module 1097 may include one or more antennas, from which at least one antenna suitable for a communication method used in a communication network, such as the first network 1098 and the second network 1099, may be selected by, for example, the communication module 1090 (for example, the wireless communication module 1092). Then, the signal or power may be transceived between the communication module 1090 and external electronic devices via at least one selected antenna.

Commands or data may be transceived between the electronic device 1001 and an electronic device 1004 outside the network environment 1000, via the server 1008 connected to the second network 1099. Each of the electronic devices 1002 and 1004 may include the same type as or a different type from the electronic device 1001. All or some of the operations performed by the electronic device 1001 may be performed in one or more of the electronic devices 1002, 1004, and 1008, outside the network environment 1000. For example, when the electronic device 1001 needs to perform a function or service automatically or in response to a request from a user or another device, the electronic device 1001 may request at least one electronic device to perform at least a portion of the function or service, instead of performing the function or service, or by adding another function of service. The one or more external electronic devices receiving the request may perform at least a portion of the requested function or service, or an additional function or additional service related to the request, and transmit the result of the performing function or service to the electronic device 1001. The electronic device 1001 may provide the result, as at a portion of the reply to the request, together with additional processing of the result or without additional processing thereof. To this end, for example, cloud computing technology, distributed computing technology, or client-server computing technology may be used.

As described above, embodiments have been disclosed in the drawings and the inventive concept. While the embodiments have been described herein with reference to specific terms, it should be understood that they have been used only for the purpose of describing the technical idea of the inventive concept and not for limiting the scope of the inventive concept as defined in the claims. Thus, those with ordinary skill in the art will appreciate that various modifications and equivalent embodiments are possible without departing from the scope of the inventive concept. Accordingly, the true scope of protection of the inventive concept should be determined by the technical idea of the following claims.

What is claimed is:

1. An electronic device comprising:
a processor configured to perform an image processing operation on a captured image generated in response to a photographing input; and
a memory configured to provide a space required for the image processing operation of the processor,
wherein the processor,
when the photographing input is received, allocates a memory space required for the image processing operation based on expected photographing pattern data generated by a machine learning model.

2. The electronic device of claim 1,
wherein, when the photographing input is received, the processor generates photographed data corresponding to the photographing input, and
wherein the photographed data comprises a photographing mode, a photographing time point, a photographing type, and a memory usage for each image processing operation.

3. The electronic device of claim 2,
wherein the processor
converts the photographing time point into a form of relative time, and
generates photographing pattern data based on the photographing time point converted into the form of relative time.

4. The electronic device of claim 3,
wherein the processor
trains the machine learning model by using the photographing pattern data, and
generates the expected photographing pattern data by using the machine learning model, and
wherein the expected photographing pattern data comprises one or more expected photographing patterns for each photographing mode.

5. The electronic device of claim 4, wherein, after a photographing operation of the electronic device is completed, the processor trains the machine learning model by using the photographing pattern data.

6. The electronic device of claim 1, wherein,
when the photographing input is received, the processor selects an expected photographing pattern having a highest probability among one or more expected photographing patterns for a photographing mode of the photographing input out of the expected photographing pattern data, and
allocates the memory space required for the image processing operation based on the selected expected photographing pattern.

7. The electronic device of claim 6,
wherein the expected photographing pattern comprises an expected time point of a subsequent photographing input, an expected probability of a photographing type of the subsequent photographing input, and expected memory usage for each image processing operation.

8. The electronic device of claim 7,
wherein the processor allocates the memory space corresponding to a reference allocation rate of the expected memory usage before the expected time point of the subsequent photographing input by using a reference time.

9. The electronic device of claim 7,
wherein the processor
determines whether to release the allocated memory space based on the expected time point of the subsequent photographing input and an expected time point of a next subsequent photographing input, and
when a difference between the expected time points of the subsequent photographing input and the next subsequent photographing input is equal to or greater than a reference difference, releases the allocated memory space step-by-step based on a reference release rate.

10. The electronic device of claim 7,
wherein the processor,
when the photographing type expected at the expected time point of the subsequent photographing input is a continuous photographing, maintains the allocated memory space until the continuous photographing is completed.

11. The electronic device of claim 6,
wherein the processor
monitors reception of a subsequent photographing input after allocating the memory space based on the expected photographing pattern, and
when an expected time point of the subsequent photographing input of the expected photographing pattern does not match a reception time point of the subsequent photographing input thereof, changes the expected photographing pattern to an expected photographing pattern having a next high probability among one or more expected photographing patterns for the photographing mode of the photographing input out of the expected photographing pattern data.

12. The electronic device of claim 11,
wherein the processor,
when an error between expected memory usage for each image processing operation of the expected photographing pattern and memory usage for each image processing operation of the subsequent photographing input is greater than a reference error, retrains the machine learning model based on photographed data corresponding to the subsequent photographing input.

13. The electronic device of claim 1, wherein the processor generates a user-customized file based on information about the machine learning model and the expected photographing pattern data.

14. A method of operating an electronic device comprising a processor configured to perform an image processing operation on a captured image generated by a photographing input and a memory configured to provide a space required for the image processing operation of the processor, the method comprising:
generating photographing pattern data based on photographed data;
training a machine learning model by using the photographing pattern data;
generating expected photographing pattern data by using the machine learning model;
receiving a photographing input; and
allocating a memory space required for the image processing operation based on the expected photographing pattern data.

15. The method of claim 14, wherein
the photographed data is generated in response to the photographing input, and comprises a photographing mode, a photographing time point, a photographing type, and a memory usage for each image processing operation.

16. The method of claim 15, wherein
the generating of the photographing pattern data comprises:
converting the photographing time point included in the photographed data into a form of a relative time; and
generating the photographing pattern data based on the photographing time point converted into the form of relative time.

17. The method of claim 14, wherein
the allocating of the memory space based on the expected photographing pattern data comprises:
selecting an expected photographing pattern having a highest probability among one or more expected photographing patterns for a photographing mode of the photographing input out of the expected photographing pattern data; and
allocating a memory space required for the image processing operation based on the selected expected photographing pattern,
wherein the expected photographing pattern comprises an expected time point of a subsequent photographing input, an expected probability of a photographing type of the subsequent photographing input, and expected memory usage for each image processing operation.

18. The method of claim 17, wherein
the allocating of the memory space based on the expected photographing pattern data further comprises:
allocating the memory space corresponding to a reference allocation rate of the expected memory usage before the expected time point of the subsequent photographing input by a reference time;
determining whether to release the allocated memory space based on the expected time point of the subsequent photographing input and an expected time point of a next subsequent photographing input; and
when a difference between the expected time points of the subsequent photographing input and the next subsequent photographing input is equal to or greater than a reference difference, releasing the allocated memory space step-by-step based on a reference release rate.

19. The method of claim 17, further comprising:
monitoring reception of a subsequent photographing input after allocating the memory space based on the expected photographing pattern;
when an expected time point of the subsequent photographing input of the expected photographing pattern does not match a reception time point of the subsequent photographing input thereof, changing the expected photographing pattern to an expected photographing pattern having a next high probability among one or more expected photographing patterns for the photographing mode of the photographing input out of the expected photographing pattern data; and
when an error between the expected memory usage for each image processing operation of the expected photographing pattern and the memory usage for each image processing operation of the subsequent photographing input is greater than a reference error, retrains the machine learning model based on the photographed data corresponding to the subsequent photographing input.

20. An electronic device comprising:
an input module receiving a photographing input from a user;
a camera module configured to generate a captured image when the photographing input is received;
a processor configured to perform an image processing operation on the captured image; and
a memory configured to provide a space required for the image processing operation of the processor,
wherein the processor, when the photographing input is received, allocates a memory space required for the image processing operation based on expected photographing pattern data generated by a machine learning model.
